(19) United States
(12) Patent Application Publication
(10) Pub. No.: US 2022/0405364 A1
(43) Pub. Date: Dec. 22, 2022

(54) System and Method for Preventing Wet Signature Legal Documents, and the Agency Relationships they Create, from Being Used to Perpetrate Fraud and Financial Abuse

(71) Applicant: Illuminote, Santa Rosa, CA (US)

(72) Inventor: Adam Eberts, Santa Rosa, CA (US)

(73) Assignee: Illuminote, Santa Rosa, CA (US)

(21) Appl. No.: 17/664,007

(22) Filed: May 18, 2022

Related U.S. Application Data
(60) Provisional application No. 63/201,906, filed on May 18, 2021.

(51) Int. Cl. G06F 21/32; G06Q 50/18; G06Q 20/02

(52) U.S. Cl. CPC G06F 21/32; G06Q 50/186; G06Q 20/023

(57) ABSTRACT

A system and method for securing and authenticating legal documents and agency relationships to prevent each from being used to perpetrate fraud and financial abuse, including a network server having a processor and memory and an executable program with code stored in said memory and configured for bidirectional communication with a plurality of network connectable devices through the Internet to accept requests from notaries and registered members to register digital copies of wet signature legal documents.

### CROSS REFERENCES TO RELATED APPLICATIONS

The present application claims the benefit of the filing date of U.S. Provisional Patent Application Ser. No. 63/201,906, filed May 18, 2021 (May 18, 2021), which is incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### SEQUENCE LISTING

Not applicable.

### BACKGROUND OF THE INVENTION

### Field of the Invention

The present invention relates most generally to an online registry and clearinghouse, and more particularly to a document and agency registry and clearinghouse system, and still more particularly to a secured cloud-based estate planning document repository that functions as both a document registry and a clearinghouse for trusteeship, power of attorney, and other financial agency relationships.

### Background Discussion

Elder financial abuse is a rapidly growing problem. Reliable data indicates that one in three elder Americans suffer financial abuse annually; the same data suggests that only 1 in 44 incidents of abuse is reported to authorities. The lack of reporting means that estimates of annual losses from elder financial abuse range wildly $1.7B to $36B. Whatever the exact number, the scope of the problem is alarming.

The number of Americans, aged 65 and over, is growing at an accelerating rate. According to the U.S. Census Bureau, there were 25.5M such Americans in 1980, growing by 37% to 35M by 2000 and 61% to 56.4M in 2020. The number is expected to soar to 82.3M by 2040. During roughly the same time period, from 1989 to 2016, the median net worth of families with a head of household age 65 or older increased by 68 percent while the median net worth of families with a head of household age 35 or younger decreased by 25 percent. Presently, over 80% of America's wealth is held by the Silent (born 1925-1945) and Baby Boomer (born 1946-1964) generations.

Accordingly, over $48 trillion of wealth is expected to change hands in the next 25 years in the United States as the Silent and Baby Boomer generations die and pass on their assets and estates to their next of kin or chosen beneficiaries. It will be the largest transfer of wealth in recorded history, and it will be governed, almost exclusively, by 16th Century estate planning documents secured by 19th Century technology.

Troublingly, the estate planning documents that will be involved in the above-described wealth transfers are vulnerable. Living trusts provide a good first example of such vulnerability. A feature of living trusts that appeals to many consumers is their confidentiality. That is, no one other than trustors and their legal representatives is entitled to learn the terms of the trust unless and until the trust becomes irrevocable, which is usually upon the death of the last trustor to die. At that time, the existence of the trust keeps the trust's assets out of probate court and away from potentially interested but unauthorized parties.

The confidentiality of living trusts is, however, also a weakness. This is due to the means by which the documents are secured. Most often, living trusts are kept in a home safe or in a binder sitting on a shelf: the first secures the document but potentially makes it inaccessible; the second makes the trust readily vulnerable to blatant fraud, sometimes accomplished as brazenly as in the replacement of a single page that changes the distribution of trust assets. Because trust amendments can be accomplished through a simple signed document, they can be drafted, executed with a forged signature, and placed in the trust binder. Thus, they are prime targets for fraud and undue influence, and that fraud will not be discovered until after the trustor dies, perhaps many years after the fraud or undue influence took place and long after evidence of it has become stale. Further, because title to trust assets can be changed with an affidavit and certification, neither of which need be signed by the trustor but only by the person claiming to be trustee, trust assets are especially vulnerable to crooks and unscrupulous family members. For these reasons, along with the fact that successor trustees may not know where all trust assets are stored and that the involved financial institution has generated its own paperwork to protect itself from liability, trust administration can be challenging.

A second example is found in powers of attorney. On their face, they are simple documents, authorizing one person, the agent, to act on behalf of another, the principal. However, powers of attorney necessarily involve third parties—those who rely on the power of attorney to transact business with the agent on behalf of the principal. Such third parties are afforded the protection of being able to rely on the power of attorney, unless and until they learn that is has been revoked or is otherwise invalid. Accordingly, after revoking a power of attorney, the principal must notify all third parties with whom the agent did business to inform them of the revocation. If the principal does not know all of those parties, then the principal cannot possibly discharge that obligation, and the agent can carry on doing business with such third parties.

Finally, there are deeds, perhaps the most vulnerable of all assets titled to a trust. All that is needed to change title to property titled to a trust is an Affidavit of Change of Trustee; the affiant does not need to provide proof that they are, in fact, the trustee. In California, County Recorders are legally obligated to record any document presented, even if they suspect fraud. This has resulted in fraudsters recording affidavits and selling property which is not theirs.

Understandably, probate litigation (aka, trust and estate litigation) has exploded. Twenty years ago, there was no such thing as a “probate litigator.” Now it is a burgeoning business. And with the looming $48 trillion dollar wealth transfer governed by 16th Century estate planning documents secured by 19th Century technology, this kind of litigation is certain to continue exponential growth—unless a technical solution can be provided to secure estate planning documents from fraud and abuse.

Sadly, the laws and financial institutions do not provide adequate protection. In matters of trusts, wills, and estates, as in criminal laws generally, the laws themselves do not proactively prevent crimes and bad acts. Rather, the system of criminal and civil penalties assessed after the damage is done is intended to discourage and deter the bad acts in the first place. But in the case of elder abuse, as in child abuse, the perpetrators often act with absolute impunity. This is because most of the perpetrators of elder financial and estate abuse are predatory caretakers, fiduciaries, or family members; victims either fail to realize what has happened or are too embarrassed or frightened to report the abuse. And the violation and exploitation of the fear, trust, and dependence of the victims, who are unable to fend for themselves and thus depend on the compassion of others, make the predator's acts unqualifiedly abhorrent and execrable.

Even when (so rarely) reported, the violation is typically investigated by overworked and underfunded adult protective services, and prosecutors to whom cases are referred pursue only those cases they regard as the most egregious (or easiest to prove), leaving the remainder to be vindicated through civil actions by civil attorneys who take such cases only at great cost to the victims and their families.

One might think that the financial institutions would be a bulwark against abuse. But their corporate self-interests are not aligned with those of trustors or even the broader public. Their duty is simple and singular: to maximize shareholder profits. Thus, financial institutions are concerned with financial abuse only when it affects their bottom line through adverse publicity or liability. They generally limit exposure to each by requiring trustors to sign non-disclosure agreements before providing assistance.

One might hope for some correction through enlightened, protective legislation. But hope is where matters have remained for years. Legislators have evidently intended corrective reforms, for instance through mandated reporting statutes, such as those embodied in California's “mandated reporters” laws for child abuse and elder abuse. But while such bills expanded the category of “mandated reporters” of abuse from caregivers and doctors reporting physical abuse to financial institutions and their employees reporting financial abuse, California comes in as both a pioneer and as an object lesson in industry power to thwart and frustrate popular will, as financial industry influence in the legislative process effectively eviscerated the statutes of protective power for elders and, perversely and paradoxically, distorted the language in the statutes such that they took a form that actually provides more protection to financial institutions than to elders, shielding the institutions from liability for failing to report obvious abuse. Decisional law shows that under the statutes as amended, state courts are constrained by the legislation, and the judges in their rulings have made clear just how much the statutes have departed from, and thus entirely fail to carry out, their original purpose. Sister states motivated to implement more effective legislation would do well to learn these lessons and take a commonsense approach to insulating their law with liability provisions that rest on and derive from ordinary negligence standards. Thus far, in California at least, legislative will is insufficient to undo the harm already done.

Until financial institutions are motivated more by social benevolence than shareholder profit, or until campaign finance reform reduces corporate influence in politics, or until the Silent and Baby Boom generations align their considerable will with their considerable wealth, it seems unlikely that the states will get out from under the boots of bankers.

Summarizing less obliquely but with pertinent summary detail, and still referring now to California as the paradigm case, the legislature believed that making financial institutions “mandated reporters” of elder financial abuse would help curb the problem. In response, the financial industry managed to remove criminal penalties for a failure to report suspected abuse, capped civil liability at nominal amounts, ensured that only the State Attorney General or a district attorney or county counsel could enforce a remedy, and correspondingly entirely foreclosed any chance at private enforcement. In the end, then, the only way that the mandatory reporting of elder financial abuse can be enforced in California is if an elected official decides to challenge a bank, which might result in a maximum recovery of $5,000, an amount hardly worth initiating a demand. Predictably, this has never happened, and it likely never will.

Notaries (a primer): It is a common misconception that having a document notarized somehow guarantees a level of legitimacy and legality. A correction to this misconception is in order: All that a notary can do is verify the identity of a signer. Not uncommonly, notarial acknowledgments are merely required to contain a disclaimer, at the top of the certificate of acknowledgment in an enclosed box, which reads: “A Notary Public or other officer completing this certificate verifies only the identity of the individual who signed the document to which this certificate is attached, and not the truthfulness, accuracy, or validity of that document.” The limitations should be apparent: A notary's job is not to verify the legality of a document nor to assess the capacity of the signatory. It is not to assess the presence of undue influence. Counterintuitively, it is not even to witness a signing event. It is merely and only to verify the identity of a signatory. That is entirely and only and exclusively and definitively . . . it. Echoing the note above, specialists in elder abuse law, having litigated numerous trust contests and elder abuse cases, after interviewing, deposing, and examining dozens of notaries public, will report that it is a rare notary who can remember any details of a signing event; they verify identity, and then they (understandably) forget it. Truly, a particular signing event is just one of countless such events, and they blur into a continuous and undifferentiable whole, all mainly uneventful experiences. Signatories likely make it a point to conduct themselves in a highly routine manner—professionally, courteously, maturely, and efficiently—and it is in that routine sameness that the particular disappears. Rarely is a signing event memorable.

Notary Journals: Some states, but not the majority, require notaries to keep a journal that theoretically provides a way to confirm that a particular notarial act took place. Typically, the journal includes some, if not all, of the following details: the date, time and type of each official act; the character of every instrument sworn to, affirmed, acknowledged or proved before the notary public (e.g., deed of trust); the signature of each person whose signature is being notarized; the facts pertaining to the method used to verify the signer's identity; the fee charged for the notarial service; and a right thumbprint of the signatory, if the document affects real property or is a power of attorney. (See, e.g., Calif. Govt. Code, § 8260.) There is no requirement that the notary record any other facts, such as where the signing took place, who else was present, or who arranged for and paid the notary. Not surprisingly, journal entries for notarial events frequently lack some of the above-indicated information, even when required.

An additional issue concerns the use of a notary as a witness. Of course, the play that role the notary must be located, if that's even possible after the passage of significant time. But notaries are wont to do what people do: they move, they die, they disappear. And if the notary can be located, for the purpose of verifying a signatory's identity, the notarization must be confirmed. That may be accomplished easily enough if the notary is active, in which event an interested party in a contested matter must obtain a copy of the page of the notary's journal pertaining to the particular notarization at issue (where such protections are even required). But if the notary is not active, then the interested party may have to rely on a journal submitted to the county clerk, again where such a protective requirement is required (even where such requirements apply, if more than a set number of years, e.g., 10 years, have passed, the county clerk may be permitted discard the notary journal).

Mercifully, most people know better than to die more than 10 years after signing a notary's journal or record book. Oh, wait, that's just plain stupid! Which is precisely what one feels when finally laying one's hands on a notary journal and finding the entry that must be relied on. Why? Because notaries frequently do not remember, or they misremember, where a signing took place, who was present, who arranged for it, and who paid for it, even when vastly less than 10 years have passed. Not infrequently, he or she may not even be able to read their own handwriting to verify documents signed.

In short, when unable to independently verify a notarial act through a journal, there is no presumption of fraud, and an interested party may never be able to resolve questions about legitimacy. This vexing problem exists in California, a state pioneering in consumer protections, including those for elders, and where notaries are required to keep journals. Thirty states have significantly less protections in place, even in this digital age when the clerical burden for document retention has been dramatically reduced.

At present, without legislative and rigorous ministerial protections designed to prevent elder abuse, there remains a need to protect elders by preserving estate plans and protecting them from fraud and undue influence. The present invention addresses these long felt and unfulfilled needs.

### BRIEF SUMMARY OF THE INVENTION

The present invention is, in its most essential aspect, a repository used as both a registry and a clearinghouse for trusts and other legal and estate planning documents. The registry protects elders by preserving their estate plans and protecting them from fraud, undue influence, and other abuses. The clearinghouse protects institutions and streamlines the handling of estate planning documents by establishing an industry standard for transacting business with trustees, attorneys-in-fact, and other agents.

The inventive system solves the problems set out in the foregoing background by providing a Document and Agency Registry and Clearinghouse by Illuminote (for brevity, variously referred to herein acronymically and for convenience as “DARCI” and/or “the DARCI system”).

Cars are registered, stocks are registered, software and appliances and home electronics and pets and bikes are all routinely registered. There is nothing precluding states from requiring its citizens to register estate planning documents. Yet, they do not. Still, absent legislation mandating such acts, there is nothing preventing individuals from themselves taking protective measures to ensure that the documents they create to dispose of their assets and possessions on death are substantially (if not entirely) immunized from unauthorized changes made by predatory abusers acting contrary to the interests of the testator/trustor. Perhaps, then, a technical solution is the kind of solution called for, and the present invention provides just such a technical solution.

Trust Registration: As a threshold matter, then, the inventive system provides means to register estate planning documents. Trust registration, for instance, is accomplished through a trust amendment made by the Member (or simply “Member,” who, in this case, is the trustor of the trust), which is then registered on DARCI. The amendment specifies that no future amendment, revocation, change of trustee, change in the designation of Trusted Persons, exercise of any power of appointment contained in the trust, or any other document that affects the terms, corpus, or beneficiaries of the trust, is valid or effective unless and until such acts are also registered on DARCI.

When registering her trust, the Member designates Trusted Persons and authorizes and requests that, in the event of an amendment, revocation, change of trustee, change in the designation of Trusted Persons, or the exercise of any power of appointment, registry administrator contact each and every Trusted Person identified in the amendment and alert them of the fact of such event or document, without identifying or specifying the substance of the event or document.

Trusted Person Alerts: The lynchpin of trust protection through the DARCI system is in the designation of Trusted Persons and the resulting Trusted Person Alerts. Each Member names (i.e., identifies) several Trusted Persons to be alerted in the event of any one of several enumerated occurrences. The Trusted Persons may be relatives, professionals, or anyone Member trusts to protect her best interests. When one of the enumerated occurrences comes to pass, an alert goes out to the Trusted Persons, advising them of a change, though not the substance of the change. The Member's privacy is maintained, but those close to the Member are notified and can check in with the Member at the very moment when the commission of fraud or exertion of undue influence would otherwise be realized.

To iterate, elder abusers currently victimize the elderly confident that their fraudulent acts or undue influence in changing an estate planning document will not be discovered for years, because in most instances they know no one is actively (and presently) monitoring proposed changes to the documents. When such actions are monitored substantially concurrently with the proposed changes through an alert system in which Trusted Persons are almost immediately alerted to the proposed document changes, it is nearly inconceivable that a fraudster could be confident of eluding detection. It is anticipated that this, in and of itself, will greatly reduce the commission of financial abuse through the unauthorized and clandestine modification of estate planning documents. When an illegitimate or suspicious change or proposed change occurs, the Member's identified Trusted Persons are alerted and thus enabled to take protective actions on behalf of the Member. This provides the best chance yet for revealing and undoing the damage and saving the Member from a harmful situation.

How DARCI Trust Registration Protects: The first way that DARCI registration protects a trust is by preserving the trust and its legitimate amendments. Along with the initial (registration) amendment, the Member registers all of the terms of the trust—the original trust, amendments, etc. These are then kept as business records with the system administrator and protected to ensure that the system includes an immutable and complete copy of the terms of the trust.

Next, the trust is assigned an 8-digit, alphanumeric DARCI Registration Number. This DARCI Registration Number is used to register trust assets, thereby putting the world on notice (constructive, if not actual) that the trust is registered with DARCI and that trusteeship can, and should, be verified through DARCI.

Third, DARCI registration preserves evidence. If there is any future litigation relating to or arising out of the trust, litigants will have better evidentiary proof than the kind of evidence currently available. Whether the additional evidence demonstrates fraud and undue influence or undercuts the criticism of a disgruntled heir, the truth is much more likely to prevail.

The fourth way DARCI can protect its Members' wishes is an outgrowth of the third advantage: viz., DARCI can be used to start the clock running on statutes of limitations and the equitable principle of laches. Disgruntled heirs often claim that a trustor lacked capacity or was unduly influenced. However, if that heir is included as a Trusted Person—meaning they were told of the fact of the proposed or actual amendment, though not the substance—then they were put on notice at the time of the amendment, and if they were concerned about capacity or undue influence, they then could have and, if interested or concerned, ought to have taken action. Courts are far more likely to dispose of trust contests quickly and expeditiously when they learn that an heir knew of the amendment at the time, but only later contested the amendment and alleged lack of capacity or undue influence after learning that the amendment was not personally favorable.

Finally, as DARCI grows and its utility as a clearinghouse is increasingly evident, trust administration will be facilitated. Rather than having disparate certifications of trust for each institution, financial institutions can accept DARCI's certification of trust and DARCI's clearinghouse as the authoritative word on trusteeship, thereby streamlining registration and changes in trusteeship. Additionally, DARCI is able to track all institutions that have verified trusteeship of any given trust, thereby giving a successor trustee a simple way to search for trust assets.

Bringing notaries into the 21st century: Notaries are well suited to confirming identity. And in centuries past a physical stamp or seal was adequate confirmation of the notarial act. However, though technology has changed, it has not been applied to the act at the center of real estate transactions and estate planning documents that facilitates the transfer of generational wealth.

The DARCI system includes a feature given the proprietary name of the “Illuminotary” system. As a primary objective, the Illuminotary system collects additional, objective information about the circumstances surrounding a notarial act, including, among other things and without limitation: who contacted the notary; when and where the notarial act takes place; who was present; and who paid for it. While in years past, these additional details would have been time consuming to memorialize and retain, technology now allows these details to be contemporaneously noted and digitally stored on servers that retain the information for future use.

The second objective achieved by the Illuminotary system is to allow instantaneous verification of the notarial act. A 16-digit alphanumeric identifier (an “Illuminotary Document Number” or ““IDN”) will be assigned to each Illuminotary notarial acknowledgment. The notary, whose identity and status as a notary has already been verified by the system in advance, inputs the additional data in real time and associates it with the IDN. Anyone looking at the document can then go to the system web site and immediately confirm the document's title, date, notary, signatory, and the fact that a declaration is on file with the system administrator. A QR code on the acknowledgment allows some users to skip the entry of 16 digits and scan to verify.

Powers of attorney: Though initially directed to use in connection with registering trusts, DARCI can readily accommodate and provide for registration of powers of attorney. These powerful documents are far too easily forged and, once copies begin to proliferate, they are far too difficult to constrain. However, registration of powers of attorney would facilitate a clearinghouse for powers of attorney, by which financial institutions can verify their legitimacy. In the event a power of attorney is revoked or a principal dies, DARCI can be utilized to inform the institutions that have inquired about that power of attorney.

Most importantly, DARCI can be used to push notifications to financial institutions upon revocation and preempt future unauthorized transactions.

DARCI can be employed to memorialize and protect wills. Because of variations in state laws, this is an especially challenging application from a legal standpoint. However, it can be implemented under some probate codes and solves the same fraud and undue influence problems as those solved for trusts. It further solves the “lost will” problem.

Deeds: Using real property law's deed delivery requirement, along with the ability of a title holder to specify a required means of delivery, DARCI can also be a tool to reduce and possibly eliminate equity theft by locking title and rendering unauthorized wild deeds to be invalid as a matter of law.

For all these reasons, DARCI will be seen to be applicable beyond trusts, to powers of attorney, wills, deeds, and any other wet signature legal document that might otherwise allow for fraud or financial abuse.

Who will benefit from DARCI registration? Simply stated, trustors, trustees, beneficiaries, and financial institutions.

Trustors: Estate planning fraud and undue influence are rarely perpetrated by sophisticated criminals; they are crimes of opportunity that happen when no one is looking. With the DARCI system, someone is looking, and that opportunity disappears. Trustors will be comfortable knowing that their wishes are being protected.

Trustees: Trustees will benefit greatly from DARCI registration. It will allow them to easily confirm their authority and seamlessly marshal assets. It will reduce the greatest headache they can face, trust litigation, in both frequency and severity.

Beneficiaries: Trust litigation can easily cost hundreds of thousands of dollars, subject beneficiaries to years of delay and uncertainty, and leave a lasting stain on the memories of loved ones. Any time that trust litigation is avoided or minimized, the intended beneficiaries benefit.

Financial Institutions: No amount of lobbying can fully protect financial institutions from errors made by front line, undertrained employees. The present inventor has experience advising trustees and agents and litigating trust and estate matters and notes a vast variation in vulnerability to error between financial institutions, within financial institutions, and often even from transaction to transaction. Whether through fraud or innocent error, it is far too easy for the wrong person to transact business as a trustee or attorney-in-fact. A financial institution that uses DARCI as a clearinghouse to confirm and update trusteeship will minimize the liability arising from, and streamline the process of working with, trustees.

One must not make the inference or draw the conclusion that the inventive DARCI system benefits everyone. Indeed, there are some who are seriously disadvantaged by DARCI: they include fraudsters, con artists, financial abusers, and trust and estate litigators.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention and which form the subject matter of the claims presented herein.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a highly schematic functional diagram showing exemplary network infrastructure for implementing the inventive system and method for preventing wet signature legal documents, and the agency relationships they create, from being used to perpetrate fraud and financial abuse;

FIG. 2 is a block diagrammatic top level critical path flow chart showing system functions at a highly abstract level;

FIG. 3 is a flow chart showing the Illuminotary registration process as implemented in the inventive system, i.e., how notaries sign up to obtain authorization to participate in the system as “Illuminotaries”;

FIG. 4 is a flow chart showing a second critical path in the system directed to how a Member (e.g., a trustor) signs up and registers an estate planning document in the registry;

FIG. 5 is a flow chart showing a third critical path in the system, namely, how the notarization process works when executed in the inventive system;

FIG. 6 is a flow chart stack showing a fourth critical path in the inventive system, namely those events that trigger the transmission of notifications to the Trusted Persons in a Member's list of Trusted Persons;

FIG. 7 is a block diagrammatic flow chart showing a fifth critical path in the inventive system, namely, the information accessible to financial institutions authorized to obtain and review up-to-date estate planning documents and information;

FIG. 8 is a flow chart showing the login/sign in process of a Member (e.g., a trustor), as implemented in the inventive system;

FIG. 9 is a block diagrammatic top level critical path flow chart showing the trust registration process at a highly abstract level from the perspective of the system, and incorporating FIGS. 8, 11, 15, and 19 therein;

FIG. 10 is a block diagrammatic top level critical path flow chart showing the trust registration process at a highly abstract level from the perspective of the Member, and incorporating FIGS. 8, 11, 17, and 20 therein;

FIG. 11 is a flow chart showing the questionnaire and associated logic required for trust registration from all perspectives;

FIG. 12 is a is a block diagrammatic top level critical path flow chart showing the process for registering a new document to the system from the perspective of the system and incorporating FIGS. 14, 15, and 19 therein;

FIG. 13 is a block diagrammatic top level critical path flow chart showing the process for registering a new document to the system from the perspective of the Member and incorporating FIGS. 14, 17, and 20 therein;

FIG. 14 is a flow chart showing the questionnaire and associated logic required for registering a new document from all perspectives;

FIG. 15 is a flow chart showing the Illuminotarization process as implemented in the inventive system from the perspective of the system and incorporating FIG. 18 therein;

FIG. 16 is a flow chart showing the Illuminotarization process as implemented in the inventive system from the perspective of the Illuminotary and incorporating FIG. 18 therein;

FIG. 17 is a flow chart showing the Illuminotarization process as implemented in the inventive system, from the perspective of the Member;

FIG. 18 is a flow chart showing the questionnaire and associated logic required for Illuminotarization from all perspectives;

FIG. 19 is a flow chart showing the process and logic for uploading an Illuminotarized document from the perspective of the system;

FIG. 20 is a flow chart showing the process and logic for uploading an Illuminotarized document from the perspective of the Member;

FIG. 21 is a flow chart showing the process and logic for the Illuminotary registration specifically from the perspective of the system; and

FIG. 22 is a flow chart showing the process and logic for the Illuminotary registration specifically from the perspective of the Illuminotary.

### DETAILED DESCRIPTION OF THE INVENTION

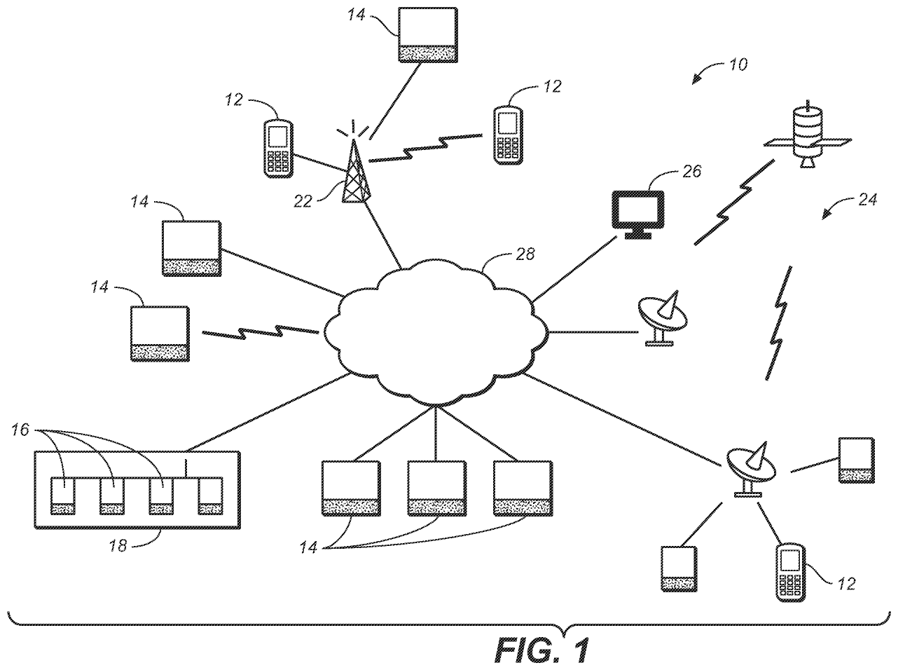

Referring to FIGS. 1 through 7, wherein like reference numerals refer to like components in the various views, there is illustrated therein a new and improved system and method for preventing wet signature legal documents, and the agency relationships they create, from being used to perpetrate fraud and financial abuse.

Referring first to FIG. 1, there is shown an embodiment of the inventive system in an exemplary network infrastructure 10. From the background discussion, it will be immediately evident that the system is intended for use on a large scale by the subscribing Members of the general public. Thus, it is contemplated that the system will find its natural expression online and on the internet, accessed by users through the World Wide Web using any of a wide variety of input devices, such as a personal data assistant or mobile/cellular phones 12, discrete laptops, tablet, or desktop computers 14, or similar network-connected data processing devices 16 connected through separate local area networks 18, either directly through wired connection or through wireless telecommunications systems and networks 22, 24. System software for the inventive system (including the registry itself and the registry management system that accesses the registry) may be hosted on a server processor having memory, a processor connected to the memory, and executable program stored in memory. The server process may be maintained on-site 26 by a system administrator, or it may be operated on a remote processor in a cloud-enabled telecommunications network 28, still under system administrator management and control, and all in a manner well known in the art, the details for which are thus unnecessary.

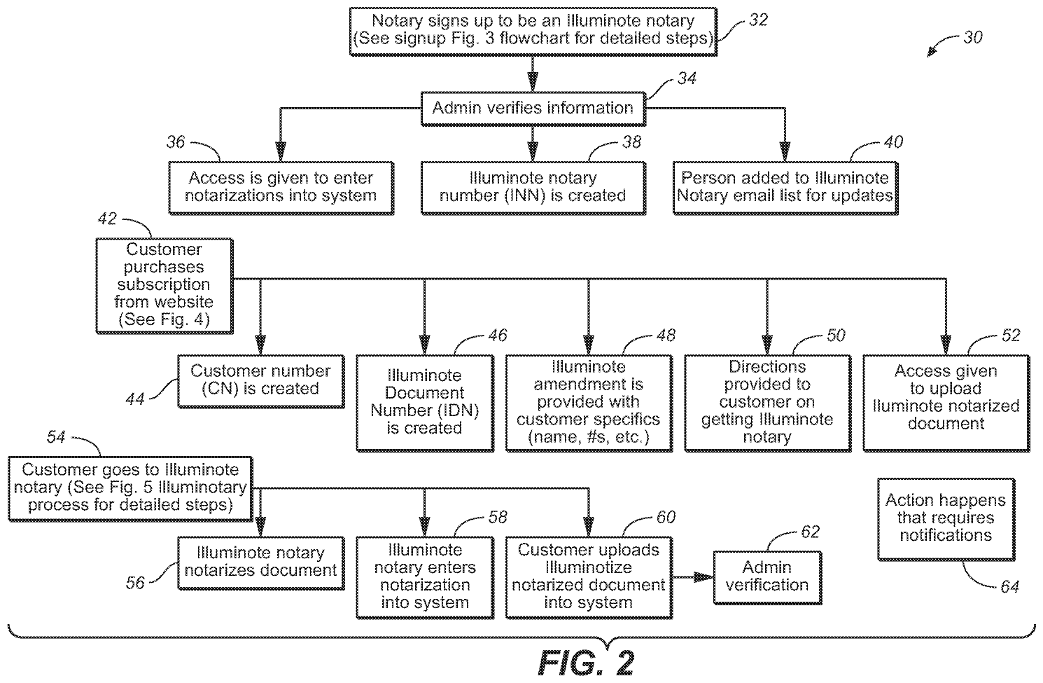

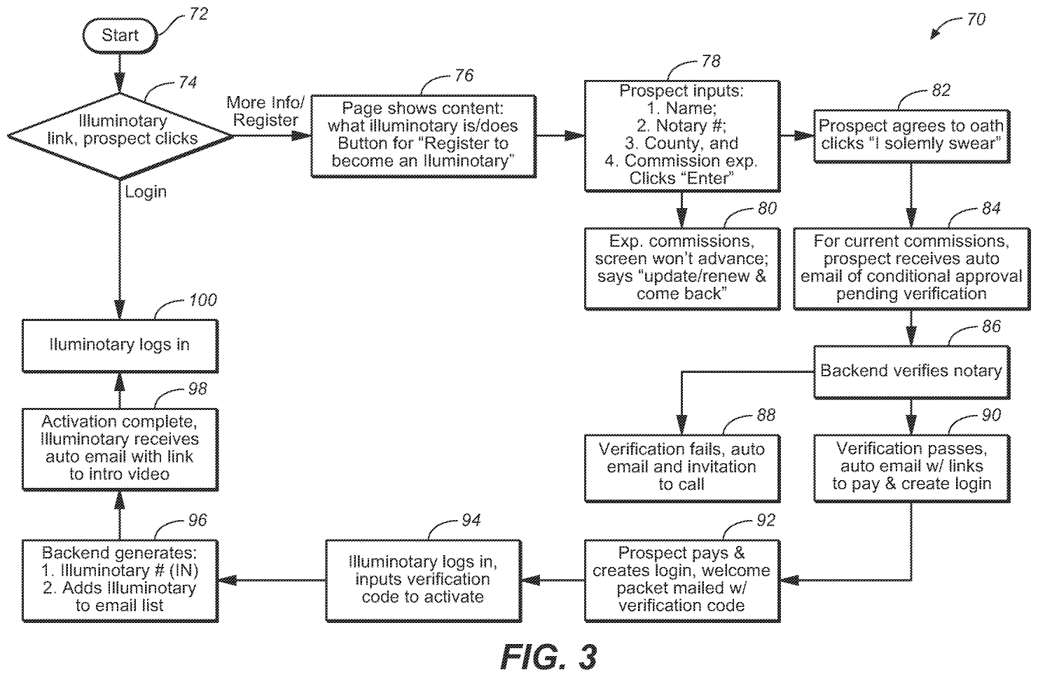

FIG. 2 shows the top-level critical path 30 of the Document and Agency Registry and Clearinghouse by Illuminote (“DARCI”) system, which system bears a proprietary name of Illuminote. At step 32 in the inventive Illuminote system, a notary, using a network connected device, accesses the Illuminote website and enters the information necessary to register and participate as an Illuminotary in the system. [Notary registration details are set out more fully in FIG. 3.] At step 34, the system administrator automatically verifies the information provided by the candidate Illuminotary and 36, creates and stores an Illuminote notary number (INN) 38, and stores the Illuminotary's email information 40 to ensure transmission of system updates to the newly authorized and registered Illuminotary as such updates become available.

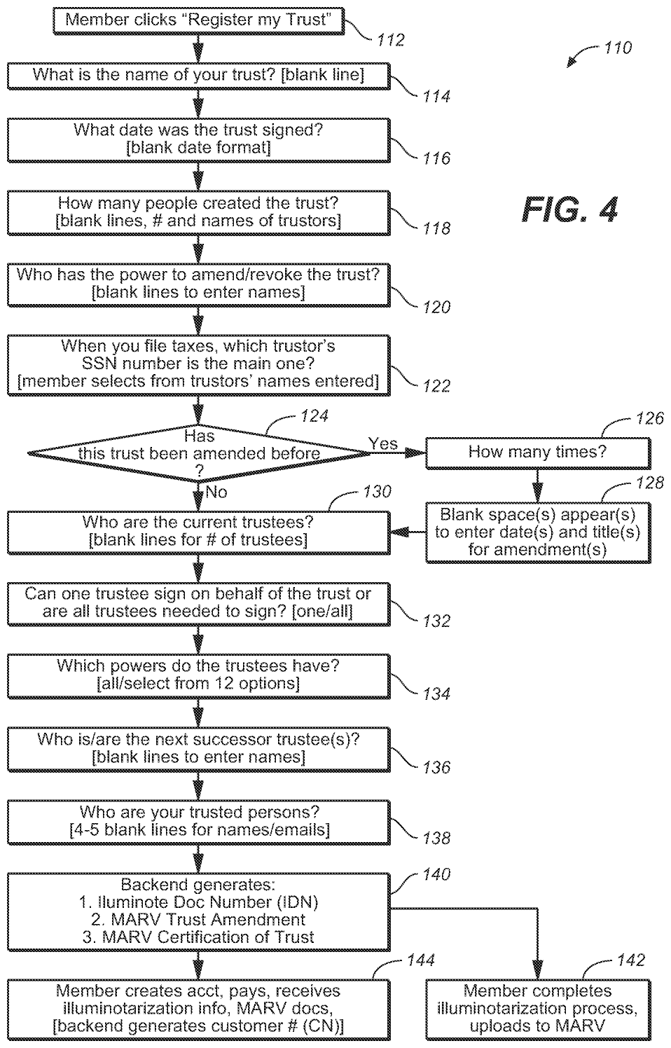

In the instant case, the term “Member” refers to a person who registers estate planning documents for protection under the Illuminote system. At step 42, a Member using a network connected device connects to the system server through the system website and purchases a subscription to use the system services. [Details of the Member subscription process are set out more fully in FIG. 4.] The system provides the Member with a member number 44 and stores the number in system memory. 46.

The Member is then provided a series of questions to answer regarding the particulars of their trust to be registered. The system generates and assigns an 8-digit alphanumeric DARCI number to the trust. With the Member information provided, including a listing of Trusted Persons to whom notices are to be sent, the system responds by generating a Registration Amendment to the trust and a Certification of Trust 48, each of which is assigned by the system its own unique IDN. At this time, the Member is instructed to print the documents and provided with direction to locate an Illuminotary 50 and, ultimately, for later upload 52.

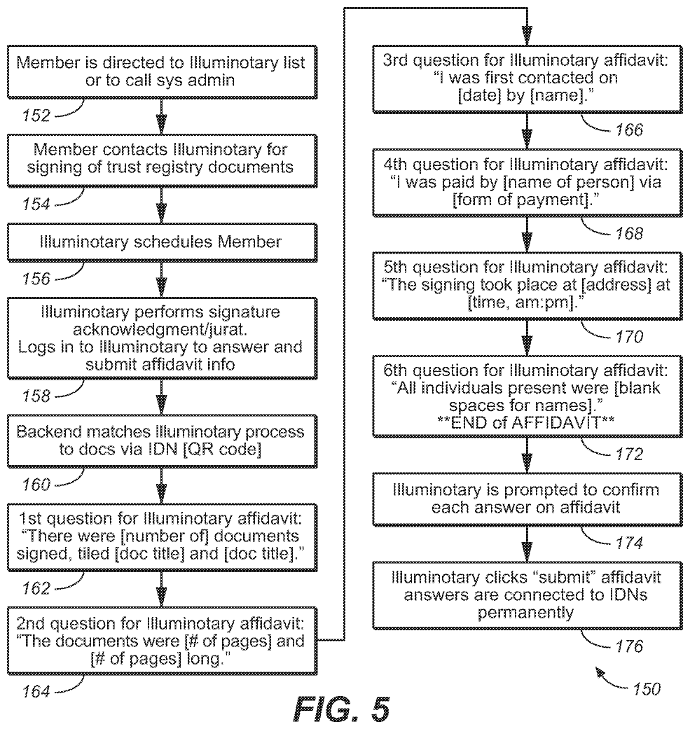

Before uploading a notarized document, the Member must locate and arrange a personal meeting 54 with the Illuminotary. At the Illuminotary event, at step 56 the Illuminotary logs into his/her account and inputs the IDN(s) of the documents that are to be Illuminotarized 420, Upon receipt of the IDNs, the system generates an access code and emails or texts it to the Member 422, who provides it to the Illuminotary to enter. Once entered, the Illuminotary can proceed forward with the notarial process as provided by law. At the conclusion of the notarial process, the Illuminotary answers system generated questions regarding the circumstances of the notarial act 58 using a network connected device. The Illuminotary is queried about the accuracy of his/her answers and affirms under penalty of perjury that the answers given are accurate. At that time, the system updates the status of each IDN from “issued” to “completed” and the system is ready to receive uploads of pictures of the documents. 60 The Member may then upload and save the Illuminotarized document(s) in the system. Once completed, the system administrator will verify 62 that the uploaded document and the notarization meet system requirements. [Details on the notarization process, as well as subsequent entry of the notarization and uploading of the notarized document, are set out in FIG. 5.]

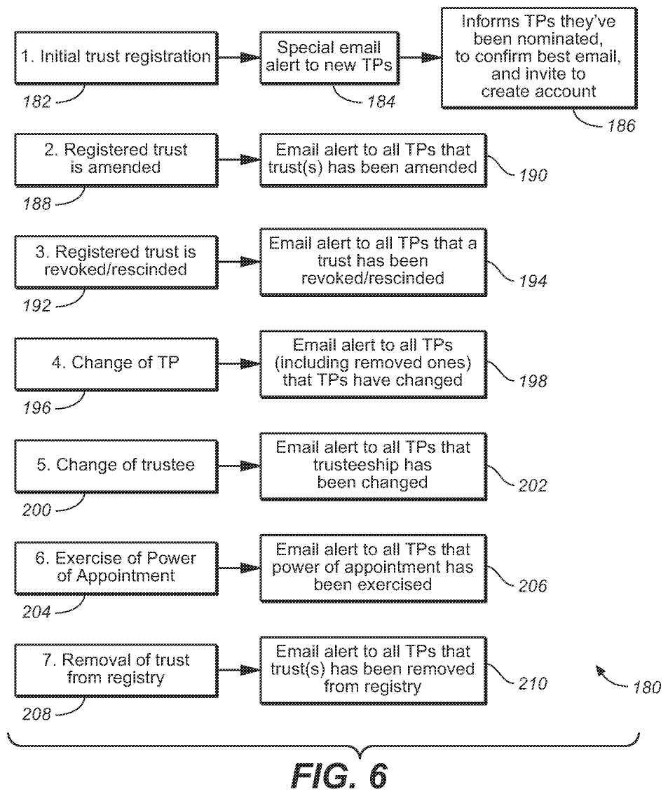

Thereafter, should one or another of several predetermined triggering events occur, notifications are sent to the Trusted Persons 64 identified by the Member at the time the subscription commenced. [Details on such triggering events are set out more fully in FIG. 6.]

FIG. 3 is a flow chart showing the system operation 70 for notaries to sign up and obtain authorization to participate in the Illuminote system. At step 72 a prospective Illuminotary accesses the system webpage 74. He or she is presented with an active hyperlink which, when clicked 74, takes the prospect to a sign-up page 76. The page includes information about what an Illuminotary is and does and provides a button for the prospect to indicate their wish to become an “Illuminotary”, i.e., a notary authorized to participate in the system and to notarize Illuminote documents.

At the registration page, the notary prospect inputs critical identifying and qualifying information 78, including name and notary number. An invalid notary will be prevented from accessing successor pages in the registration process and will be prompted 80 to update and/or renew the commission and return thereafter. If the notary is valid, the prospect will be prompted to swear an oath that the information provided is true and accurate 82. Again, if the notary is valid, the system will automatically generate and transmit an email to the prospect 84 detailing the next steps and advising them a verification code will be mailed to their address on file with the Secretary of State, and a link to pay for the registration and to set up the notary login. When the notary pays the registration fee and creates a login 92, a postcard is sent with a verification code 86, 88, 90. The new notary (now an “Illuminotary”) then logs in to the system to input the verification code provided, and this activates the registration 94. The system backend generates and records the Illuminote notary number (INN) and adds the Illuminotary to the system email list for sending information and updates 96. With the activation complete 98, the system automatically sends the Illuminotary an introductory video via email or text. The Illuminotary is thereafter able to log in to the system to enter notarizations into the system.

FIG. 4 provides details on the second critical path 110 in the system, directed to how a Member (e.g., a trustor) registers an estate planning document in the registry. The process begins with the Member accessing the Illuminote website and clicking a “Register my Trust” hyperlink 112. The system then prompts the Member to answer a series of questions and provide information to qualify a document for registration in the system, including: the name of the trust 114; the date the trust was signed 116; the number of people involved in the creation of the trust 118; the individuals who have authority to amend or revoke the trust 120; the primary trustor Social Security Number identified when filing trust federal tax returns 122; whether the trust has been previously amended 124; if yes, how many times 126; the dates and times of the prior amendments 128; if the trust had not been previously amended, the names of the current trustees 130; whether one trustee signature is sufficient or all trustee signatures are required for trust actions 132; the express powers of the trustees 134; the identity of successor trustees 136; and a listing of Trusted Persons, with full contact information 138. With this information entered in the system, the system backend generates an Illuminate document number for the document, a DARCI trust amendment, and a DARCI certification of trust 140. The Member then completes the Illuminotarization process by uploading the document to DARCI, and the system server records and stores the document 142. At step 144, the Member creates his or her account, pays for the services, receives the Illuminotarization information, the DARCI documents, and the backend generates the Member number.

FIG. 5 is a flow chart showing a third critical path 150 in the system, namely, how an actual notarization process is implemented using the inventive system. Here is it seen that the Member is directed by a transmitted message 152 to consult a listing of geographically proximate Illuminotaries he or she may elect to consult. Alternatively, the Member will be instructed to contact the system administrator to get suitable names. The Member may then contact the Illuminotary 154 to sign documents in the Illuminotary's presence. The Illuminotary will schedule the signing 156, perform a signature acknowledgement at a mutually convenient time and place, and log in to the system to provide notarization information and an affidavit 158. The system backend then matches the Illuminotary process to Illuminote documents using the IDN 160 (such as through a QR matrix barcode).

The Illuminotary affidavit requires that the Illuminotary provide answers to a succession of questions, including: the number of documents signed and the document titles 162; the number of pages in each document, indicated by title 164; how the Illuminotary was contacted 166; who paid for the Illuminotary services 168; where the signing took place 170; and the individuals present at the place of signing 172. The Illuminotary is then prompted to confirm each answer on the affidavit 174, and when so confirmed, the Illuminotary clicks on a clickable “submit” call to action (CTA) button on the webpage 176. The affidavit submission process is thereby completed.

FIG. 6 is a stacked flow chart showing a fourth critical path 180 in the inventive system. This illustration shows the events that trigger the transmission of notifications to the Trusted Persons in a Member's list of Trusted Persons. These include: the initial trust registration itself 182, after which the system generates a special email 184 and transmits the email 186 to each Trusted Person to alert them that they have been nominated by the trustor(s) to act in the capacity of a Trusted Person. The system further invites the Trusted Persons to create an account in the system.

A second event that will trigger a Trusted Person (TP) notification is when a registered trust is amended 188. Such an event triggers an email 190 informing the TPs of the fact (not substance) of the amendment. The same holds for a revocation or rescission of a registered trust 192, which triggers a transmitted notice of the same 194 to the TPs; a change in a TP 196, which triggers an alert to all TPs 198, including those removed; a change in a trustee 200, which triggers a notice of the same 202; the exercise of a power of appointment 204, which triggers an alert 206 that a power of appointment has been exercised; and the removal of a trust from the registry 208, which triggers an alert to all TPs 210 that the trust has been removed.

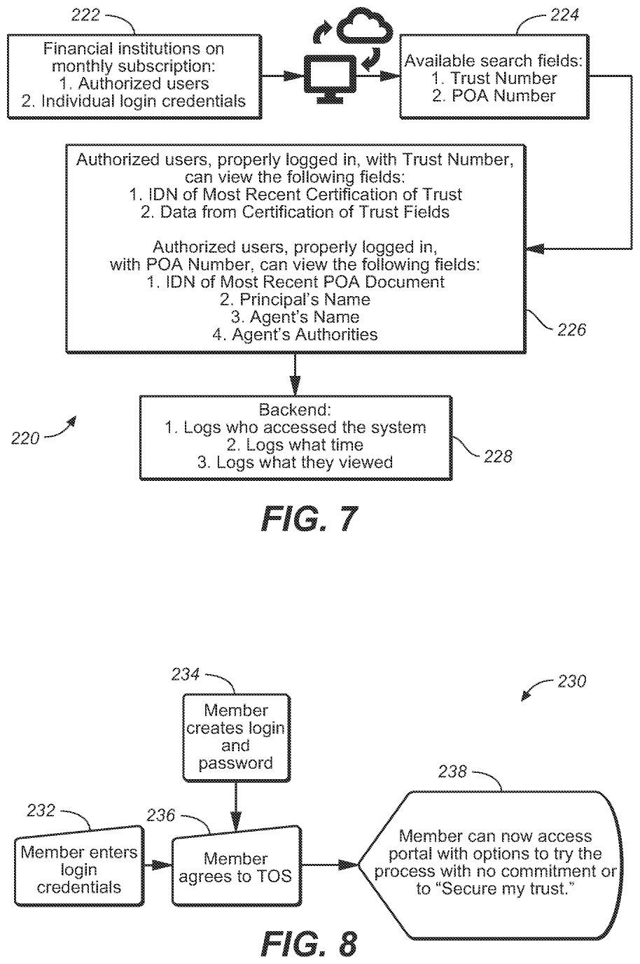

FIG. 7 is a block diagrammatic flow chart showing a fifth critical path 220 in the inventive system, showing the kind of information accessible to financial institutions authorized to obtain and review up-to-date estate planning documents and information. As can be seen, financial institutions having monthly subscriptions to the system may include a number of authorized users with individual login credentials 222. When the authorized users log in to the system, they may search the system database using available search fields 224, which, at a minimum, include trust number and power of attorney number. At step 226, authorized users with a Trust Number may view the Illuminote Document Number (IDN) of the most recent certification of trust, as well as date from the Certification of Trust fields. Authorized users with a POA number may view the IDN of the most recent POA document, the principal's name, the agent's name, and the agent's various authorities. At step 228, the system backend records and stores a log of who accessed the system, the time, and the elements viewed.

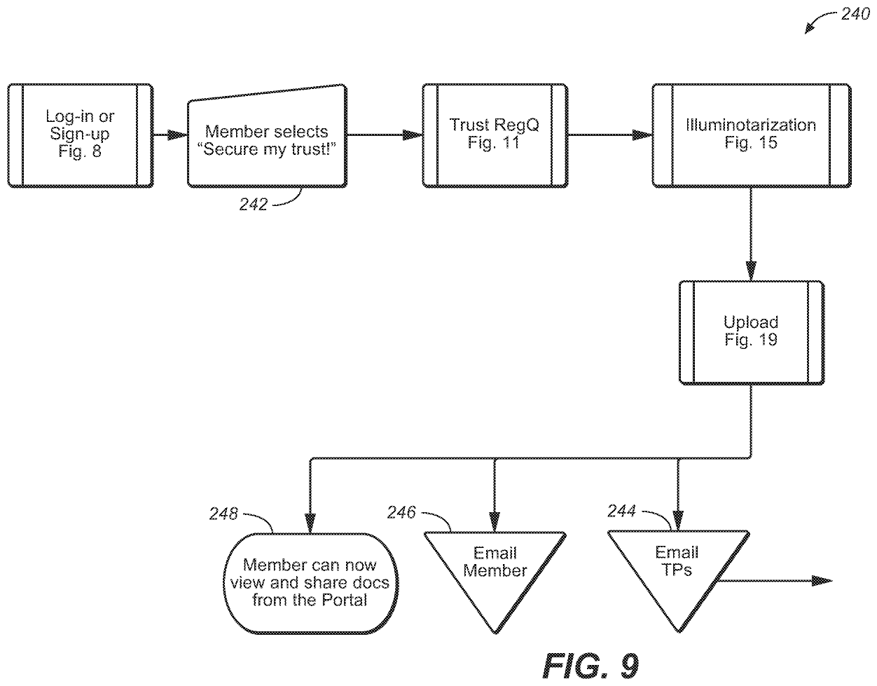

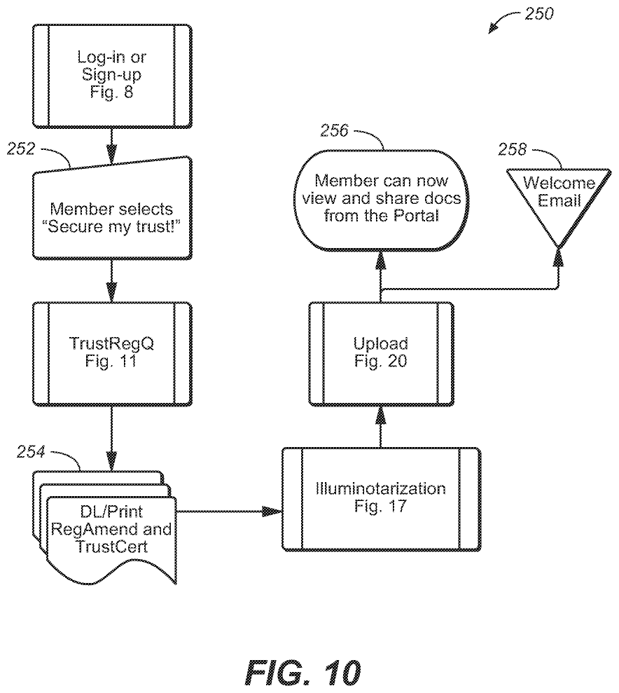

Referring to FIGS. 8 through 22, there is illustrated therein a new and improved system and method, set forth from the various perspectives of the Member, the inventive system itself, and the notary, for preventing trusts and trusteeship, specifically, from being used to perpetrate fraud and financial abuse.

FIG. 8 is a flow chart showing the login/sign-in process of a Member (e.g., a trustor), as implemented in the inventive system 230. At step 234, a new Member signs up and must first create a username and password and agree to Terms of Services 236. Upon completion, they can access the portal and try the system with no commitment or move forward with securing their documents 238. At step 232, existing Members login to view their portal showing their documents and actions taken on their account 238.

FIGS. 9-11 are block diagrammatic top level critical path flow charts showing the trust registration process at a highly abstract level from all the perspectives and is an expansion of steps 240, 250, 260 set out in FIG. 4.

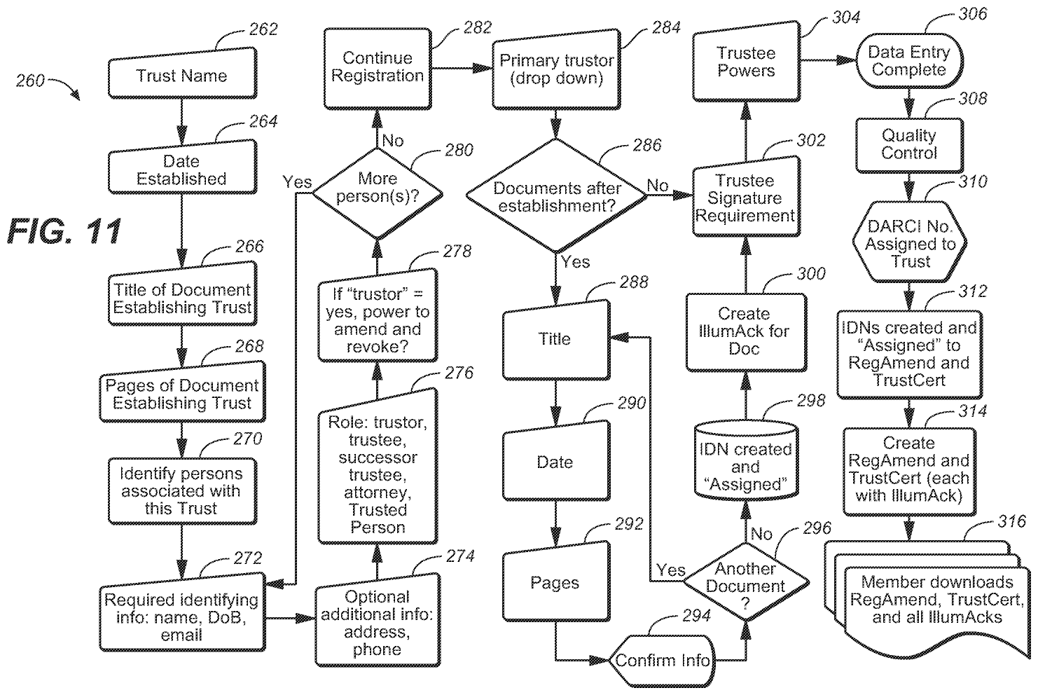

FIG. 9 shows how the inventive system responds to the data provided by the Member 240. First, the Member or prospective member signs up or logs in, as set forth in FIG. 8. Upon selecting “secure my trust” 242, the system will move the Member through the required interviews, steps of which are set forth in detail in. FIGS. 11, 15, and 19 and incorporated herein, before emailing their Trusted Persons 244, emailing the Member 246, and allowing the Member access to the portal 248.

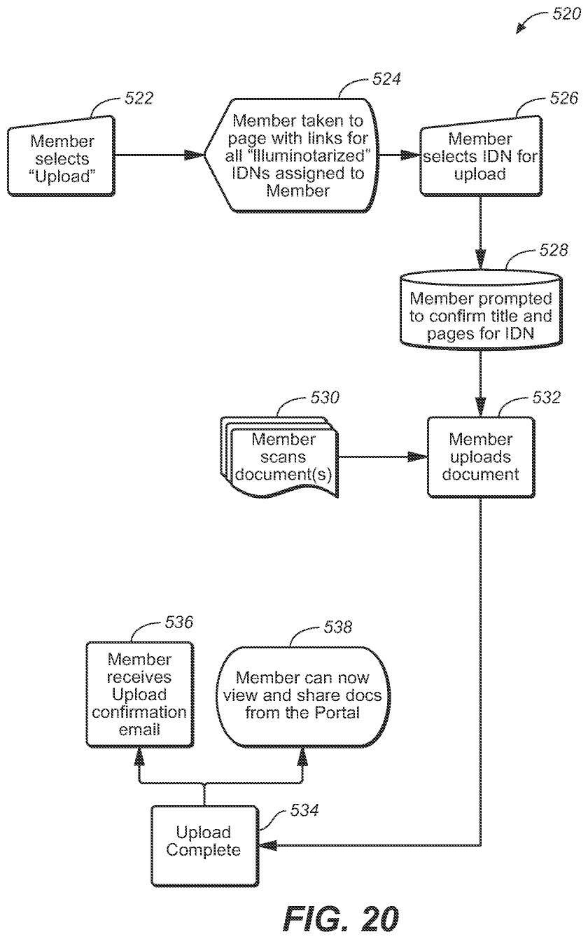

FIG. 10 shows what the Member experiences as the Member interacts with the inventive system 250 when selecting “secure my trust” 252. The inventive system refers to and incorporates the steps set forth in FIG. 11 to advance to step 254, where the Member is prompted to download and print the onboarding system documents for trust registration. The inventive system refers to and incorporates/executes the steps set forth in FIGS. 11 and 20 to advance to Applicant: Illuminote, Inc. step 256, at which time the Member can access the portal and view and/or share documents. At step 258, the Member receives a welcome email.

FIG. 11 shows the inventive system's questionnaire, in combination with associated logic required, for trust registration from all perspectives. The Member completes a questionnaire consisting of a series of questions that will enable the system to generate the onboarding documents 260. These questions include name of trust 262, date it was established 264, title of document establishing trust 266, the number of pages establishing the trust 268, identity of person(s) associated 270, identifying information of those persons 272, optional info 274, the roles of person(s) associated 276, trustor power to amend and revoke 278, and any additional person(s) 280. The questionnaire continues the registration 282 and asks who the primary trustor is, if there is more than one 284. The system then moves onto whether any additional documents were added after the trust establishment 286, and if so, title 288, date 290, pages 292, and requests information confirmation 294. The documents are added to the system one at a time, and if there are additional documents to register, steps 286-292 repeat for each document. Upon completion of adding documents, the system will create an Illuminote Document Number (“IDN”) and assign to the Member Declaration setting forth documents comprising the trust 298. The system will then generate a Member Declaration for the Member to sign acknowledging the documents are the complete set 300. The system continues to engage the Member by asking the Member to input the manner of trustee signature requirement to act on the trust 302 and the extent of trustee powers 304. At this point in the questionnaire, the data entry is complete and the system will engage in quality control 308. If quality control is satisfied, the system will then generate a unique DARCI number and assign it to the Trust 310. Next, the system will generate IDNs for the two remaining onboarding documents, the Registration Amendment and Trust Certification 312, and attach those IDNs to the two onboarding documents it generates 314. The Member can now download the Member Declaration, Registration Amendment, and Trust Certification 316.

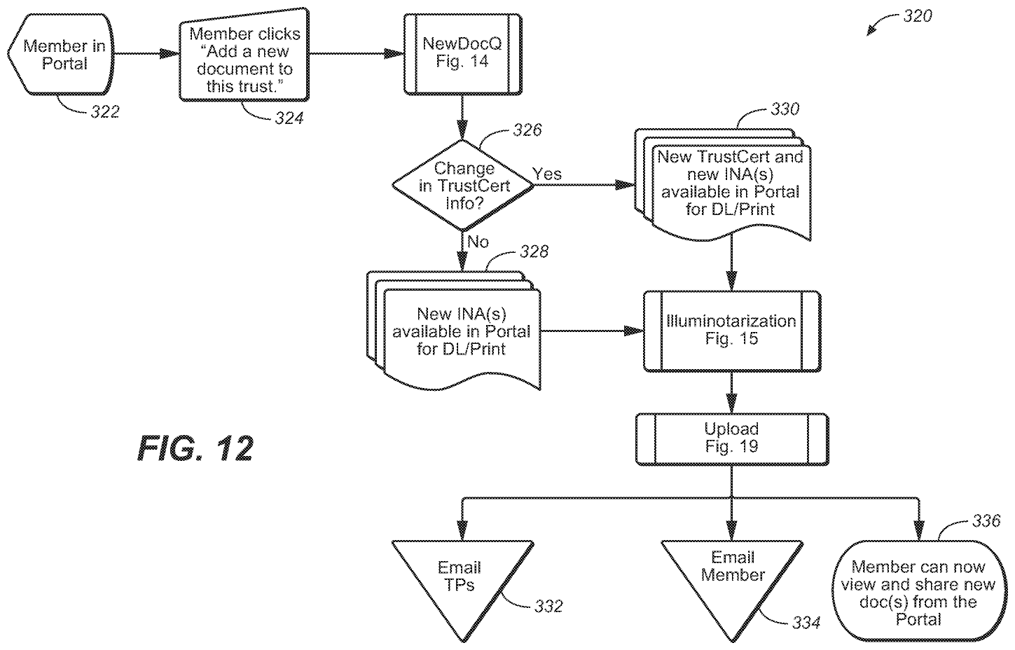

FIGS. 12-14 are block diagrammatic top level critical path flow charts showing the process at a highly abstract level from all the perspectives for the registration of new documents (e.g., new amendments or change of trustee documents that come into existence after the trust is registered).

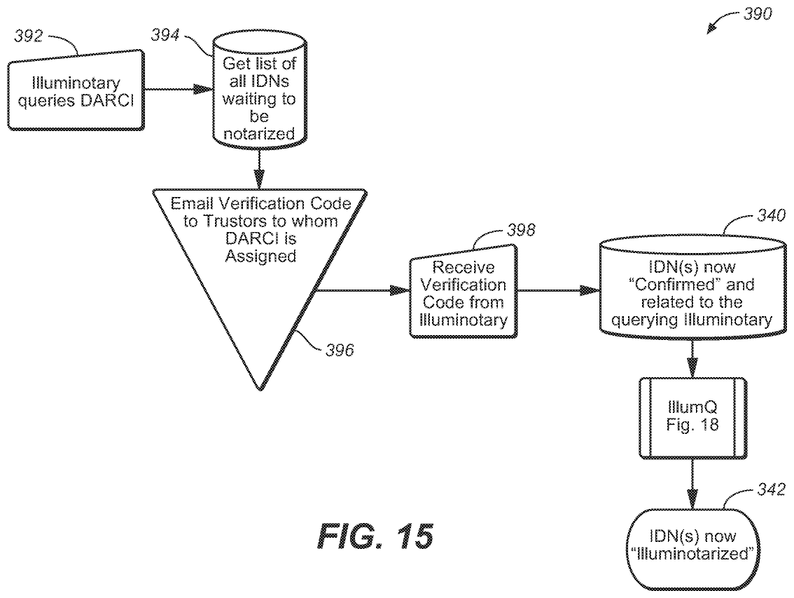

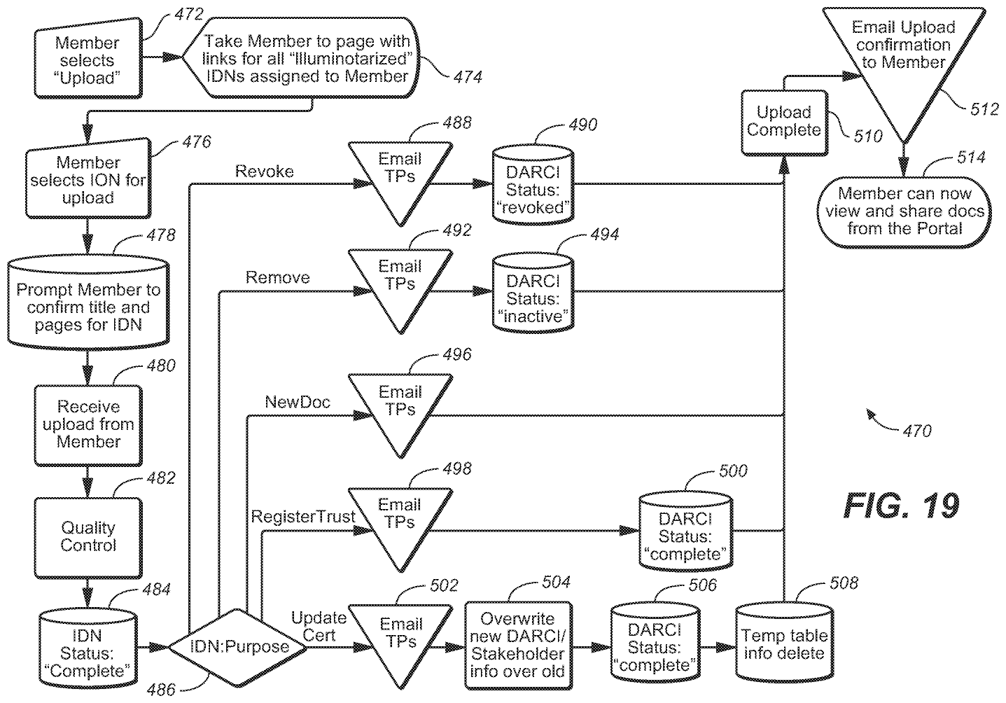

FIG. 12 shows how the inventive system responds to the data provided by the Member when adding a document after initial trust registration 320. First, the Member initiates the process by logging in, as set forth in FIG. 8. Next, the Member starts this process by selecting add a new document to their already-registered trust 324. The system responds by determining whether the new document changes any of the stored data for the Member's current Trust Certification 326. If the answer is negative, the system will generate a new Illuminotary Notarial Acknowledgement (“INA”), with corresponding new IDN, for the new document in the portal for download and printing 328. If the answer is affirmative, the system will generate a new Trust Certification, with corresponding new IDN, and a new INA with corresponding new IDN, for download and printing 330. When the Member completes the system requirements and uploads the system generated documents, the steps of which are set forth in detail in FIGS. 15 and 19, this triggers the inventive system to email the Trusted Persons 332 and email the Member 334. The Member can now view and share the newly added documents in the portal 336.

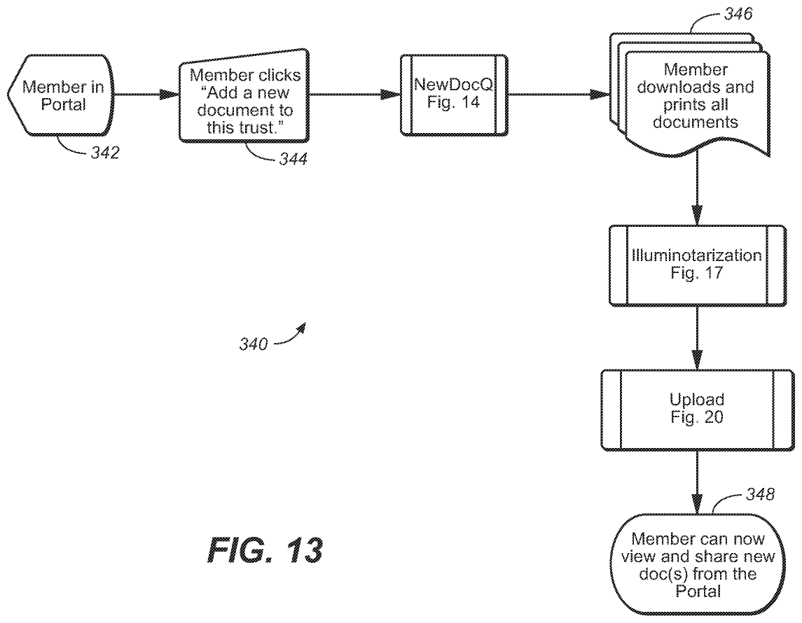

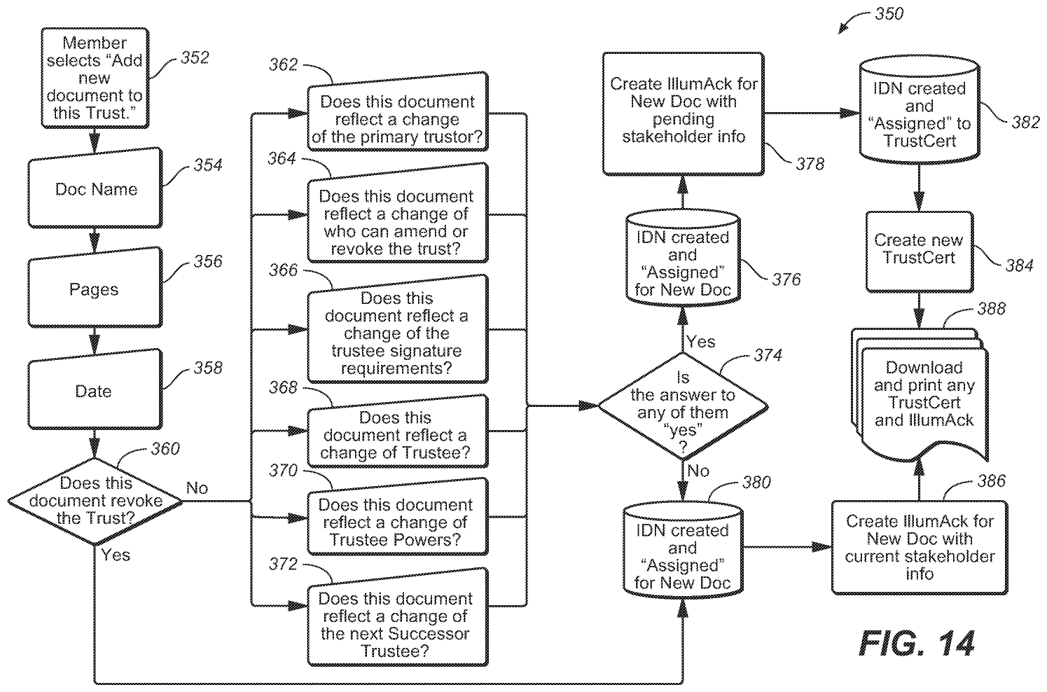

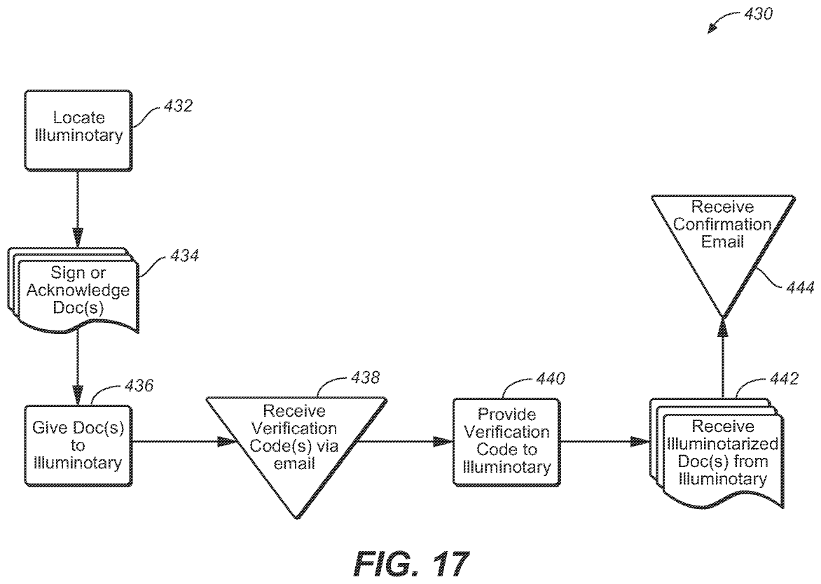

FIG. 13 shows what the Member experiences as they interact with the inventive system to add a new document to their previously registered trust 340. Member logs in to portal 342 and selects add a new document to their trust 344. The inventive system proceeds through new document interview set forth in FIG. 14. The Member downloads and prints all required documents 346. The process loop is closed by Member following process for Illuminotarization and upload set forth in FIGS. 17 and 20, respectively. Member can now view and share the new documents from the portal 348.

FIG. 14 shows the questionnaire, in combination with associated logic required, for registration of new documents from all perspectives 350. Member selects add new document to existing trust 352. The inventive system inquires as to the document name 354, its number of pages 356, its date 358, and whether the new document revokes the trust 360. At this point, different critical paths are triggered depending on Member responses. If the response to the previous question is affirmative, the inventive system will generate and assign a new IDN for the document 380, and create the INA 386 for the Member to download and print 388. If the answer to the revocation question is negative, the inventive system will determine whether a new Trust Certification is required. It does this by asking a series of questions such as, does the document reflect a change of primary trustor 362, does the document reflect a chance of who can amend or revoke the trust 364, does the document reflect a change of the trustee signature requirements 366, does the document reflect a chance of trustee 368, does the document reflect a change of trustee powers 370, and does the document reflect a chance of the next successor trustee 372. If the answer to any of the questions 362-372 is YES 374, a new IDN is created and assigned to new documents 376. If the answer to any of the questions 362-372 is NO, the inventive system will generate and assign a new IDN for the document 380 and create the acknowledgment 386 for the Member to download and print 388. If the answer to any of the questions 362-372 is YES, the inventive system will create and assign an IDN for the new document 376 and create the INA for the new document 378, create and assign an IDN to the new Trust Certificate 382, and generate the new Trust Certificate 384 for the Member to download and print 388.

FIGS. 15-18 are block diagrammatic top level critical path flow charts showing the process at a highly abstract level from all the perspectives for the Illuminotarization of documents 390, 410, 430, and 450.

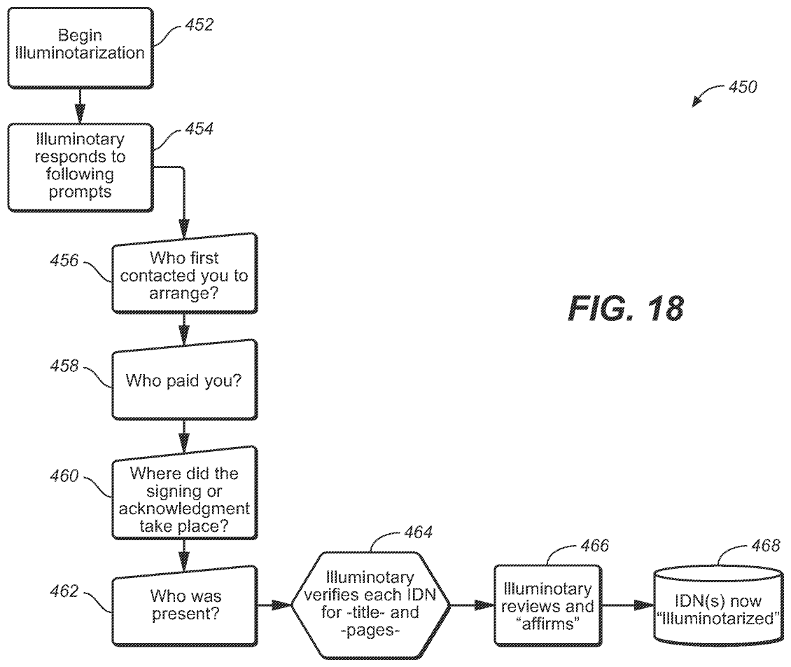

FIG. 15 shows how the inventive system responds to the data provided by, and provides data to, the Notary and Member 390. At step 392, the Notary inputs the DARCI number assigned to the trust that they are Illuminotarizing. The inventive system responds to the Notary's query by providing the list of all IDNs associated with that batch that are pending notarization 394. The inventive system then emails a Verification Code 396 to the Member to whom the IDN was assigned, and the Member provides the Verification Code to the Notary to complete the cycle 398. At step 400, the IDNs are now confirmed and displayed for the Notary. The inventive system then runs the Notary through the Affidavit process, as set forth in detail in FIG. 18. The IDNs are now Illuinotarized 402.

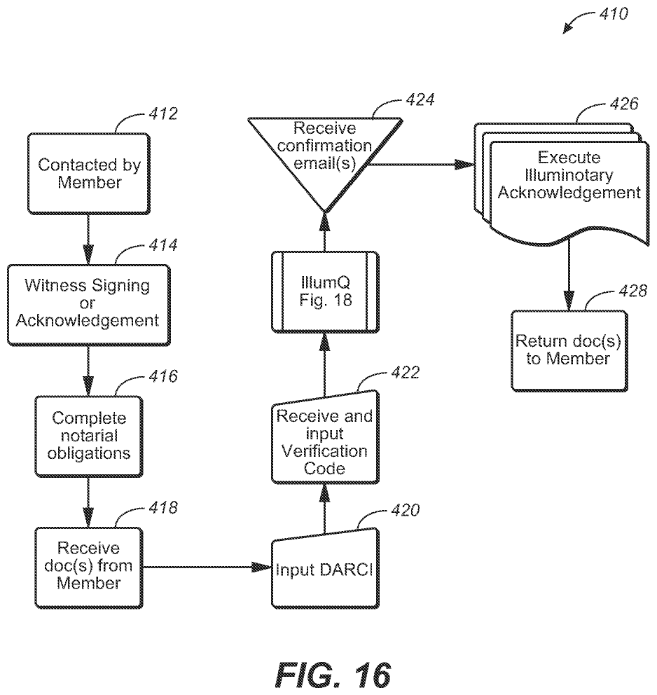

FIG. 16 shows what the Notary experiences as they interact with the inventive system and Member 410. At step 412, the Notary is contacted by the Member to perform notary/Illuminotary services. The Notary observes Member either sign or acknowledge the signature on the document 414. At step 416, the Notary completes the notarial act and receives the documents from the Member 418. At step 420, the Notary inputs the DARCI number of the documents and receives and enters the Verification Code the Member provides 422. The inventive system then runs the Notary through the Affidavit process, as set forth in detail in FIG. 18. At step 424, the inventive system sends a conformation email to the Notary and the Notary executes the Illuminotary acknowledgement 426. The process is complete, and the Notary returns the documents to the Member 428.

FIG. 17 shows what the Member experiences 430 as she interacts with the inventive system and Notary. The Member locates an Illuminotary through the inventive system 432. The Member then either signs or acknowledges to the Notary 434 that they have signed the documents. At step 436, the Notary gives the signed documents to the Illuminotary, receives the Verification Code from the inventive system 438 via email, provides the Verification Code 440 to the Illuminotary, and receives the Illuminotarized docs 442 from the Illuminotary. The inventive system generates an email confirmation to the Member 444.

FIG. 18 shows the questionnaire, in combination with associated logic required, for Illuminotarization, 450 from all perspectives. The Notary begins the Illuminotarization process 452 and inputs objective responses to these prompts 454: who first contacted you 456; who paid you 458; where did the signing or acknowledgment take place 460; and who was present 462. At step 464, the Illuminotary verifies each IDN for matching title and page information, reviews and affirms if correct 466 and the IDNs are now Illuminotarized 468.

FIGS. 19 and 20 are block diagrammatic top level critical path flow charts showing the process at a highly abstract level from all the perspectives for the uploading of new documents to the inventive system (e.g., new amendments or change of trustee documents that come into existence after the trust is registered).

FIG. 19 shows how the inventive system responds to the data provided 470 by the Member for document uploading. At step 472, the Member chooses the option to upload completed documents. The inventive system directs the Member to a page 474 which displays all the outstanding IDNs assigned to that Member where the Member can select the appropriate IDN for upload 476. The system prompts the Member to confirm title and correct number of pages for the IDN selected 478 and receives the upload from the Member 480 and runs quality control 482 and document accuracy exists, change the IDN status to “complete” 484. Next, the inventive system will direct the Member to one of four possible routes based on the IDN's purpose 486: original trust registration, additional document, revoke a registered document, or remove a registered document. For original trust registration, an email is triggered to Trusted Persons 498 and the inventive system will change DARCI status to “complete” 500. The inventive system will simultaneously generate the Trust Certification 504, email Trusted Persons 502, and change the DARCI status to “complete”. The temporary table info in the inventive system will be deleted, 508 upload is complete, 510 and the Member will be emailed confirmation 512. The Member can now view and share documents from the Portal 514. If the route determined by the inventive system is a new document, the critical path consists of emailing Trusted Persons 496 and depending upon the responses to the inquiries, may or may not generate and updated Trust Certification. If generation of a new Trust Certification is triggered, Trusted Persons will be emailed 502, old information will be overwritten 504, and DARCI status will change to “complete” 506 with any temporary table information being deleted 508. If the inventive system ascertains that the purpose of the IDN is to revoke a registered trust, initiation of the operation involves an email to Trusted Persons 488 and DARCI status changed to “revoked” 490. The upload is complete 510, the Member is emailed confirmation that upload is complete 512 and Member can view or share the revoked documents from the Portal 514. If the inventive system ascertains that the purpose of the IDN is to remove a registered trust, initiation of said operation involves an email to Trusted Persons 492 and DARCI status changed to “inactive” 494. The upload is complete 510, the Member is emailed confirmation that upload is complete 512.

FIG. 20 shows what the Member experiences as they interact with the inventive system for the uploading of new documents 520. The Member initiates the protocol by selecting “upload” 522 which will direct the Member to the page with links for all “Illuminotarized” IDNs assigned to Member 524. From there, Member chooses the IDN for uploading 526 and the system will ask the Member to confirm the title and number of pages for each IDN 528. Next, the Member scans 530 and uploads 532 the document to complete upload process 534. The system will send the Member an email confirming upload 536 and the Member can now view and share documents from the Portal 538.

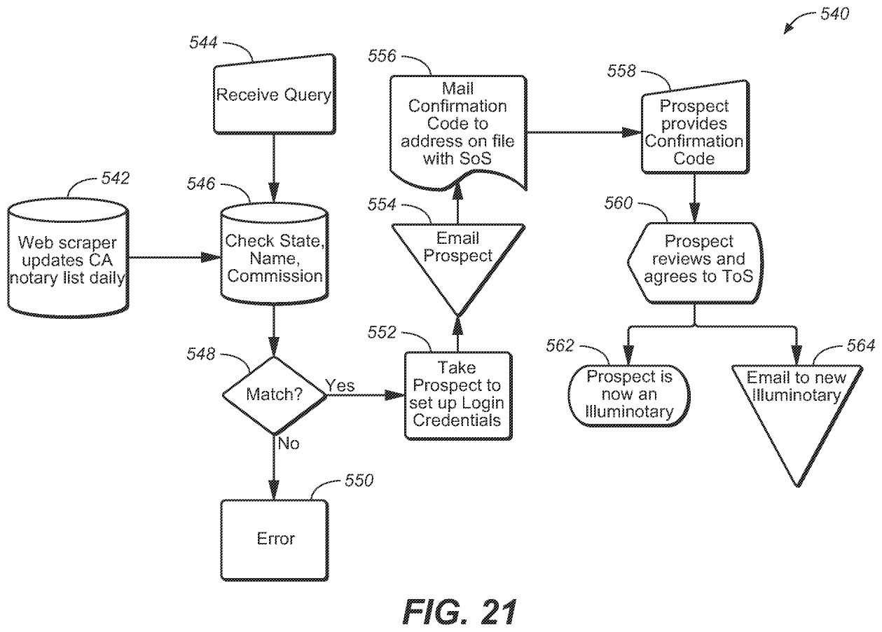

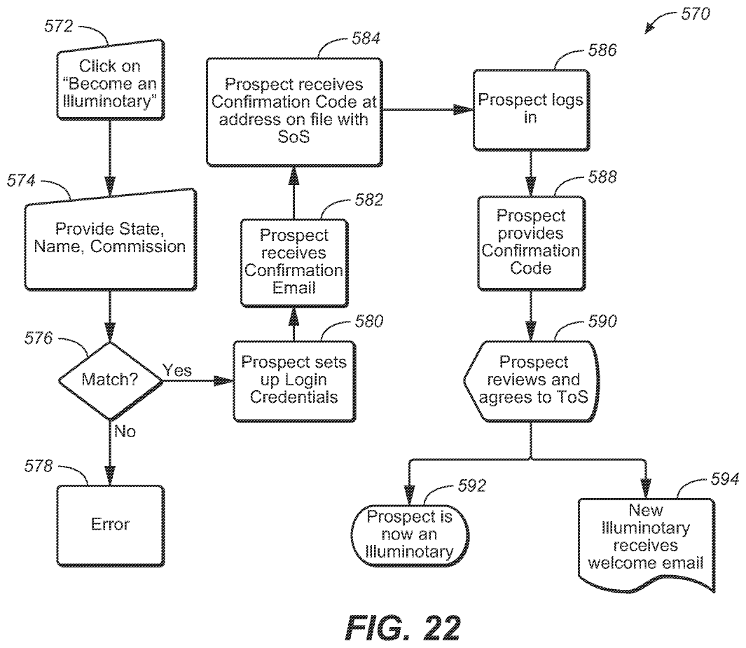

FIGS. 21 and 22 are block diagrammatic top level critical path flow charts showing the process for qualifying to become an Illuminotary at a highly abstract level from all the perspectives; this is a detailed expansion of FIG. 3.

FIG. 21 shows how the inventive system responds to the data provided by the prospective Illuminotary 540. At step 542, the inventive system will scrape California's notary website listing data for valid notaries daily for updates. Upon receipt of a query to become an Illuminotary 544, the inventive system matches the prospective notary against this list by validating state, name, and commission 546. If a match is found, the inventive system moves to step 552 by directing the prospective Illuminotary to create login credentials. If no match is found, the inventive system will return an error message 550. At step 554, the validated prospective notary receives and email from the inventive system and a Confirmation Code will be sent to the prospective Illuminotary to their address on file with California's Secretary of State 556 as determined by the inventive system's web scraper. The prospective Illuminotary logs back into the inventive system to enter the Confirmation Code 558, reviews and agrees to Illuminote, Inc.'s Terms of Service, 560. Inventive system now classifies the prospect as an Illuminotary and an email is sent 564.

FIG. 22 shows how to become an Illuminote Notary or “Illuminotary” and the interaction with the inventive system from that perspective 570. The prospective Illuminotary clicks on “Become an Illuminotary” to start the process 572. The prospect enters her state, name, and commission 574. The inventive system will return a match 576 or error 578 response. The match response continues the process by directing the prospect to create login credentials 580 to which the inventive system will email the prospect a confirmation 582 and further instruction regarding a Confirmation Code 584 that will be sent to their address on file with the California Secretary of state. At step 586, the prospect logs in and provides the Confirmation Code they received 588, reviews and agrees to Illuminote, Inc.'s Terms of Service 590 and becomes an Illuminotary 592. Lastly, the new Illuminotary receives a welcome email from the inventive system.

The above disclosure is sufficient to enable one of ordinary skill in the art to practice the invention and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes, and equivalents will readily occur to those skilled in the art and may be employed, as suitable, without departing from the true spirit and scope of the invention. Such changes might involve alternative materials, components, structural arrangements, sizes, shapes, forms, functions, operational features, or the like.

Therefore, the above description and illustrations should not be construed as limiting the scope of the invention, which is defined by the appended claims.

What is claimed as invention is:

1. A system and method for securing and authenticating legal documents and agency relationships to prevent each from being used to perpetrate fraud and financial abuse, comprising the steps of:
providing a network server having a processor and memory and an executable program with code stored in said memory, wherein said server and said executable program are configured for bidirectional communication with a plurality of network connectable devices through the Internet, and further wherein said server and said executable program,
(a) accept registration requests from notaries to register with the system so as to enable registered notaries to enter notarizations into said system and, for qualifying notaries, to register the notary in the system;
(b) register members who have connected with said network server using a network-connectable device and who have provided qualifying registration information;
(c) register digital copies of wet signature legal documents provided by registered members (“registered documents”);
(d) accept and save instructions from registered members relating to registered documents, including, at a minimum,
(i) the title of the document;
(ii) the date of document execution;
(iii) the parties identified in the or beneficiaries under the document;
(iv) the persons who have power to amend or revoke the document;
(v) the amendment history of the document;
(vi) a list of trusted persons and their contact information, the trusted persons being those to whom alerts are sent on the occurrence of a predetermined and specified events;
(e) assign an identification number (IDN) to the registered document;
(f) accept notarized documents from registered notaries; and
(g) automatically generating and transmitting an alert to trusted persons on the occurrence of any of the predetermined and specified events of substep (d)(iv).

2. The system and method of claim 1, wherein the step (a) registration of notaries includes:
providing a registration page accessible through the internet for prospective notaries to register with the system;
accepting identifying and qualifying information from the prospective notary, an individual natural person, including at least the name and notary number;
if the notary is invalid, preventing access to any successor pages in the registration system and prompting the prospective notary to address the disqualifying issue and return to registration thereafter;
if the notary is valid, prompting the prospective notary to swear an oath that the information provided is true and accurate;
if the notary is valid, automatically generating and transmitting an email to the prospective notary detailing the next steps in the registration process and advising that a verification code will be mailed to their address on file with the Secretary of State;
providing a link for a valid notary to pay for the registration;
setting up a login for the prospective notary;
sending a communication with a verification code to the prospective notary;
enabling the prospective notary to log in to the system to input the verification code provided, thereby activating the registration;
generating and recording a notary number (INN) for the newly registered notary; and
adding the registered notary to a system email list for sending information and system updates;
wherein when the foregoing steps are complete, the registered notary is able to log in to the system to enter notarizations into the system.

3. The system and method of claim 2, further including the step of sending the newly registered notary an introductory video on system use via email or text.

4. The system and method of claim 2, wherein the step (c) registration of digital copies of wet signature legal documents provided by registered members is directed to registration of an estate planning trust and includes:
enabling a registered member to login to the system;
providing access to the registered member a trust registration webpage;
providing to the registered member at the trust registration webpage a hyperlink prompting the registered member to register a trust;
providing the registered member a system of successive prompts through which the registered member may provide answers to a series of questions having information that may qualify a document for registration in the system, the information including the name of the trust, the date the trust was signed, the number of people involved in the creation of the trust, the individuals who have authority to amend or revoke the trust, the primary trustor Social Security Number identified when filing trust federal tax returns, the number of times the trust has been previously amended, the dates and times of the prior amendments, the names of the current trustees, the number of trustee signatures required for trust actions, the express powers of the trustees, the identity of successor trustees, and a listing of trusted persons to whom alerts are to be sent on the occurrence of predetermined specified events, including full contact information;
generating a document number for the document and assigning it to the document;
generating and attaching to the numbered document a trust amendment that specifies kinds of occurrences, predetermined and specified events (“triggering events”), that will generate an automatic alert to be sent to the trusted persons and authorizing the system administrator to send such alerts on the happening of such triggering events;
generating a certification of trust;
accepting and saving the document when uploaded by the registered member;
recording and storing the document in the system server; and
transmitting the generated trust amendment and certification of trust to the registered member.

5. The system and method of claim 4, wherein the predetermined and specified events that cause an alert to be automatically generated and sent to trusted persons include the initial trust registration itself, amendment of a registered trust, a revocation or rescission of a registered trust, a change in the list of trusted persons, a change in a trustee, an exercise of a power of appointment, and the removal of a trust from the registry.

6. The system and method of claim 5, wherein in response to an initial trust registration, the system software generates a special email and transmits the email to each trusted person to inform them that they have been nominated by the trustor(s) to act in the capacity of a trusted person, the email including an invitation to each trusted persons to create an account in the system.

7. The system and method of claim 5, wherein in response to the occurrence of any one or more of the specified and predetermined events, an alert is sent to all trusted persons notifying them of the fact of the occurrence.

8. The system and method of claim 1, wherein step (f), accepting notarized documents, includes:
transmitting to a registered member a message directing the registered member to consult a listing of geographically proximate registered notaries to consult or advising the registered member to contact a system administrator to obtain a listing of registered notaries;
after the registered member has contacted the registered notary, signed documents in the registered notary's presence, obtained a signature acknowledgement from the registered notary, allowing login access to the registered notary to provide notarization information;
matching the notarial process to registered documents using the IDN assigned at step (e);
obtaining from the registered notary an affidavit requiring the registered notary to provide answers to a succession of questions, including the number of documents signed, the document titles, the number of pages in each document, indicated by title, how the registered notary was contacted, who paid for the registered notary services, where the signing took place, and the individuals present at the place of signing; and
accepting a submitted affidavit when all affidavit questions are answered and the registered notary requests to submit the affidavit.

9. An internet-based system for securing and authenticating wet signature legal documents, and the agency relationships they create, from being used to perpetrate fraud or financial abuse or from interference with those agency relationships, comprising:
a server having a server processor, memory configured to store executable software, wherein said system and said executable program are configured for bidirectional communication with a plurality of network connectable devices through the Internet, and further wherein said server and said executable program are configured to,
(a) receive and record “sign-up” or registration data from one or more users of network-connectable devices through which data can be input and transmitted, wherein once the sign-up data is received and recorded, the user is a “Registered Member”;
(b) receive and record information from legal notaries, verifying the veracity of identifying information for the notary and the validity of the notary, assigning a notary number to the notary, and registering the notary so as to provide authorization for the notary to enter data and images into said system;
(c) receive and register digital copies of wet signature legal documents (“Registered Documents”) from Registered Members registered through step (a) as well as information relating to such Registered Documents, including, among other things,
(i) the name of the legal document;
(ii) the date the document was executed;
(iii) the parties or beneficiaries under the document;
(iv) the persons who have power to amend or revoke the document;
(v) the amendment history of the document;
(vi) a list of trusted persons and their contact information (“Trusted Persons”), the Trusted Persons being those to whom alerts are to be sent on the occurrence of a triggering event, which include, inter alia, an attempt to amend, modify, revoke or rescind, change Trusted Persons, change a trustee, exercise a power of appointment, remove the trust from the registry, or in any way change the Registered Document (“triggering events”);
(vii) a statement prohibiting any future amendment, revocation, change in trustee, change in the designation of Trusted Persons, exercise of power of appointment, and removal of trust from said registry, specifying that the exercise of any power of appointment contained in the Registered Document that affects the terms, corpus, parties, beneficiaries under the document, is invalid or ineffective unless and until such acts are also registered in said system;
(d) save the Registered Documents registered in step (c) as business records within said system memory;
(e) assign Registration Numbers to the Registered Documents and agency relationships to put third parties on notice that a Registered Document or agency relationship is registered in and can be verified through said system; and
(f) on the occurrence of any one or more of the triggering events occurs, using said executable code to automatically send an alert to the Registered Member and the registered Member's designated Trusted Persons advising the alert recipients about the fact and nature of any change or proposed change, thereby assuring the validity of data through both the Registered Member and the Trusted Persons concurrently with the triggering event.

10. The system and method of claim 9, further including step (c)(viii), receiving and registering an express request and instructions from the Registered Member to have Trusted Persons notified in the event of the occurrence one or more of the triggering events.

11. The system and method of claim 9, further including the step of receiving and recording information concerning notarial acts from notaries, the information including, inter alia, the person or entity who contacted the notary, when and where the notarial act took place, who was present during the notarial act, and who paid for the notarial act.

12. The system and method of claim 11, further including a method of instantly verifying notarial acts of notaries registered under step (b), comprising:
assigning a number (an “IDN”) or a QR code to a notarial acknowledgment;
receiving data in real time from the registered notary;
associating the data with the IDN or QR code;
providing access through said system to enable users to confirm the document title, date, notary, signatory, and filed declaration connected with the notarized document bearing the IDN or QR code.

13. The system and method of claim 9, wherein the wet signature legal documents and agency relationships secured and authenticated with said system and method includes trusts, wills, deeds, and powers of attorney.

14. The system and method of claim 9, further including the steps of providing and accepting subscriptions from financial institutions and upon request from a financial institution, providing clearinghouse services by confirming and updating changes in trusteeship for Registered Documents that are trusts.

15. The system and method of claim 9, further including the steps of providing and accepting subscriptions from financial institutions and upon request from a subscribing financial institution, providing clearinghouse services by confirming and updating changes in powers of attorney for Registered Documents that are powers of attorney.
